(19) United States
(12) Patent Application Publication
(10) Pub. No.: US 2026/0065162 A1
(43) Pub. Date: Mar. 5, 2026

(54) Proficiency Dashboard System

(71) Applicant: Ramin Bolouri, Concord, CA (US)

(72) Inventor: Ramin Bolouri, Concord, CA (US)

(21) Appl. No.: 19/313,822

(22) Filed: Aug. 28, 2025

Related U.S. Application Data
(60) Provisional application No. 63/688,235, filed on Aug. 28, 2024.

(51) Int. Cl. G06N 20/00; G06F 11/34

(52) U.S. Cl. CPC G06N 20/00; G06F 11/3428

(57) ABSTRACT

A software system evaluates an artificial intelligence (AI) model across predefined tasks and optional simulated scenarios, computes task-level and aggregated proficiency metrics, stores those metrics keyed to model versions, and displays them on an interactive dashboard featuring real-time updates and side-by-side version comparisons. In certain embodiments, a data capture layer logs user interactions; an incremental training layer updates the model without full retraining; a proficiency scoring module benchmarks performance against human standards; and a versioning module maintains a longitudinal record. The dashboard surfaces strengths, weaknesses, improvements, and regressions and can present fairness/bias indicators and simulation tools for “what-if” testing, thereby increasing transparency and reliability of AI deployments.

### CROSS-REFERENCE TO RELATED APPLICATIONS

Not applicable. If priority or domestic benefit is later sought, the cross-reference will be provided in an Application Data Sheet per 37 C.F.R. § 1.76 and § 1.78.

### STATEMENT REGARDING FEDERALLY SPONSORED RESEARCH OR DEVELOPMENT

Not applicable. No federal funding or obligations known at the time of filing.

### REFERENCE TO A SEQUENCE LISTING, A LARGE TABLE, OR A COMPUTER PROGRAM LISTING APPENDIX ON READ-ONLY OPTICAL DISC

Not applicable. No sequence listing, large table exceeding 50 printed pages, or computer program listing appendix is being submitted on read-only optical media.

### BACKGROUND OF THE INVENTION

### Field of the Invention

The present invention relates to evaluation, monitoring, and transparent reporting of artificial intelligence (AI) model performance. More particularly, it concerns systems and methods for computing and displaying proficiency metrics for AI models—across versions, tasks, and scenarios—through an interactive dashboard.

### Description of Related Art

As AI systems permeate critical workflows, standard MLOps tooling typically surfaces coarse metrics (e.g., accuracy, loss) and production health signals (e.g., drift alerts) but often lacks fine-grained, task-level proficiency views, version-aware comparisons, embedded simulation, or user-facing transparency. Existing dashboards focus on system health or anomaly detection, and model documentation initiatives (e.g., model cards) tend to be static and not continuously updated in lock-step with model versions. These limitations obscure strengths, weaknesses, and regressions across model iterations.

Prior efforts cover fragments of the overall problem—e.g., production efficacy tracking and alerting, or separate platforms for validation and retraining—but do not disclose a unified architecture that (i) evaluates models across skill categories and simulated scenarios, (ii) stores proficiency data version-by-version with full auditability, (iii) provides user-driven simulation, and, in certain embodiments, (iv) benchmarks proficiency against human performance standards and supports incremental, context-aware learning from user interactions.

### BRIEF SUMMARY OF THE INVENTION

The invention provides a software system that evaluates an AI model against predefined tasks and optional simulated scenarios; computes task-level and aggregated proficiency metrics; stores those metrics keyed to model versions; and exposes them in a real-time dashboard with version comparison tools. In embodiments, the system further includes (a) a data capture layer that logs user interactions and model behaviors, (b) an incremental AI training layer that updates the model from captured context without full retraining, (c) a proficiency scoring module that quantifies performance relative to human benchmarks, (d) a versioning module that maintains a longitudinal proficiency history, and (e) interactive simulation tools allowing users to test “what-if” scenarios and compare versions side-by-side. These capabilities make model learning trajectories transparent, highlight regressions, and provide trustworthy, user-interpretable insight into model proficiency over time.

### BRIEF DESCRIPTION OF THE SEVERAL VIEWS OF THE DRAWING

FIG. 1 is a block diagram of an example proficiency dashboard system 100, illustrating an AI model 102, an evaluation engine 110, a performance data repository 120 (including 122 task definitions store, 124 raw outputs log, 126 metrics store, 128 version history), a dashboard interface module 130, a data capture layer 140, a simulation environment 150, an incremental AI training layer 160, a proficiency scoring module 170, a versioning module 180, and a security/privacy subsystem 190, together with representative data and control flows among these components.

FIG. 2 is a flow diagram of model evaluation and metrics update, showing stages to retrieve inputs 210, obtain model outputs 212, compare to expected 214, and compute/store metrics 216 into the repository 120, with optional scoring passes by module 170.

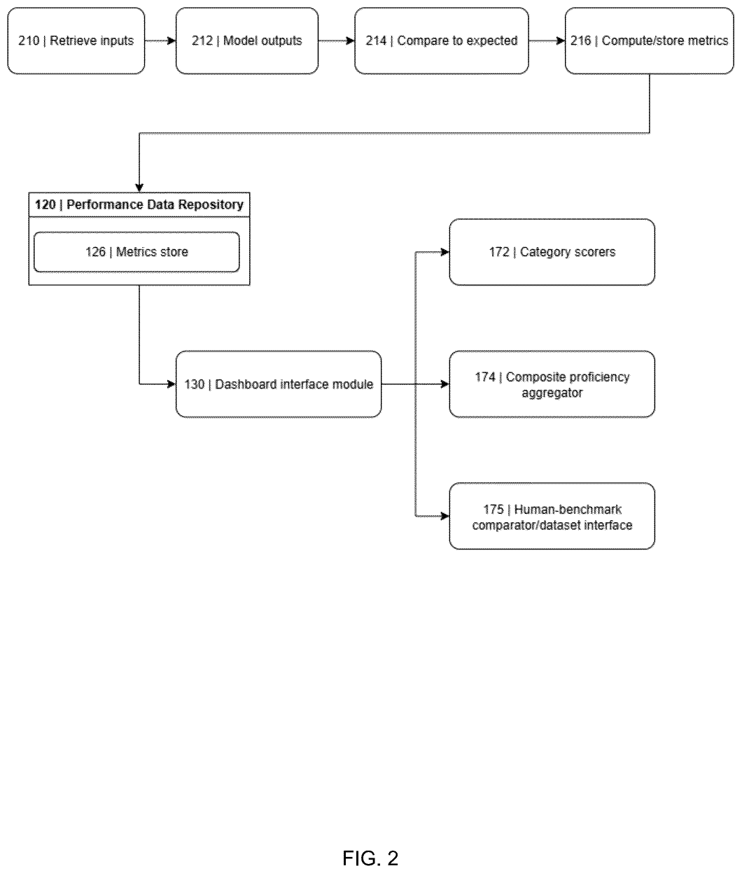

FIG. 3 is a schematic wireframe of a dashboard user interface 300 that presents category charts 310, a metrics table 320, an overall proficiency indicator 330, simulation tools 332, an alert indicator 336, a fairness/bias panel 338, an explainability panel 340, and an audit viewer 342.

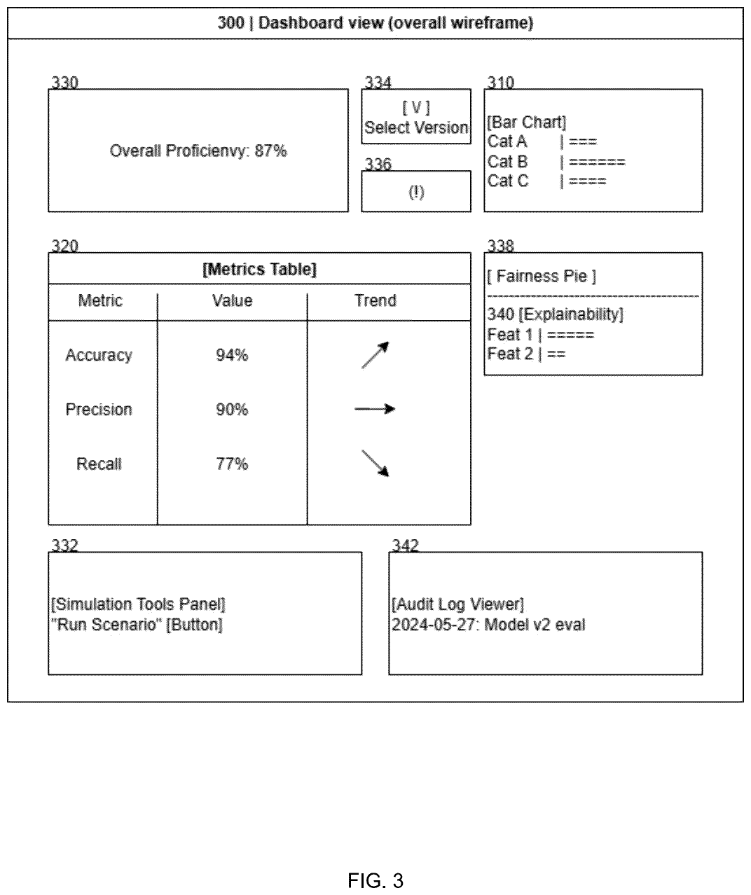

FIG. 4 is a version-comparison view 400 showing version-selection controls 334, prior-version metrics 410 and new-version metrics 420 displayed side-by-side, with a differences highlight 430 and an optional regression alert 440.

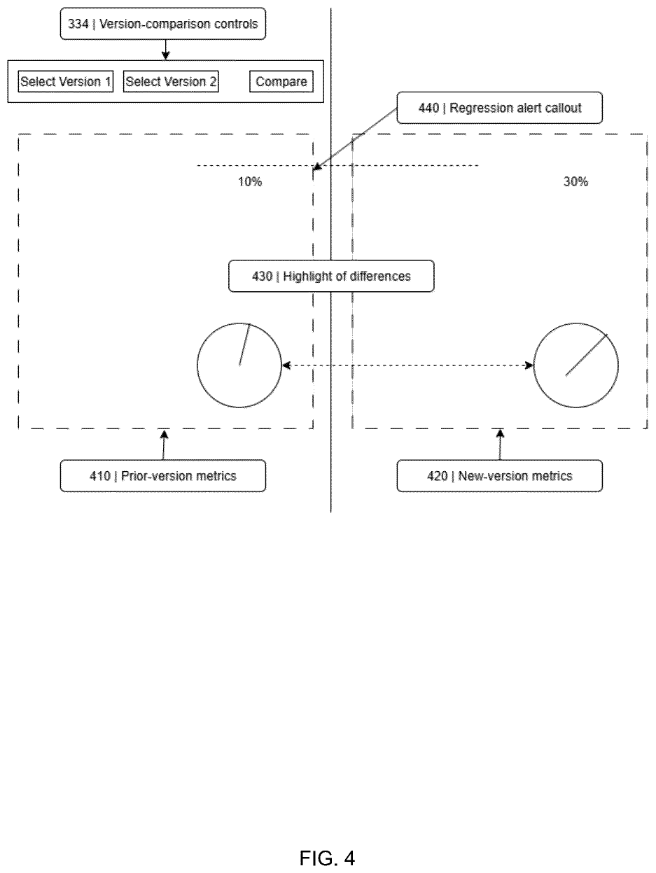

FIG. 5 is a schematic of the simulation environment 150 interacting with the AI model 102, wherein scenario inputs 502 are supplied to the model and scenario outputs/telemetry 504 are returned to the evaluation engine 110 for scoring and storage.

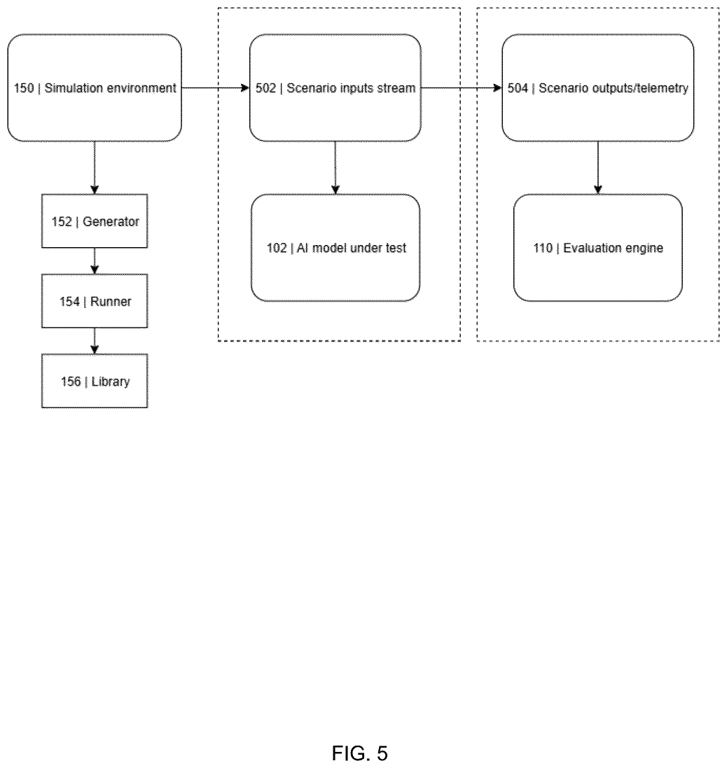

FIG. 6 is a block diagram of data capture and incremental learning, depicting the data capture layer 140 with interaction logger 142, behavior classifier 144, and anonymizer/filter 146 feeding the incremental training layer 160 with online trainer 162, update scheduler 164, and anti-forgetting regularizer 166, which updates the AI model 102.

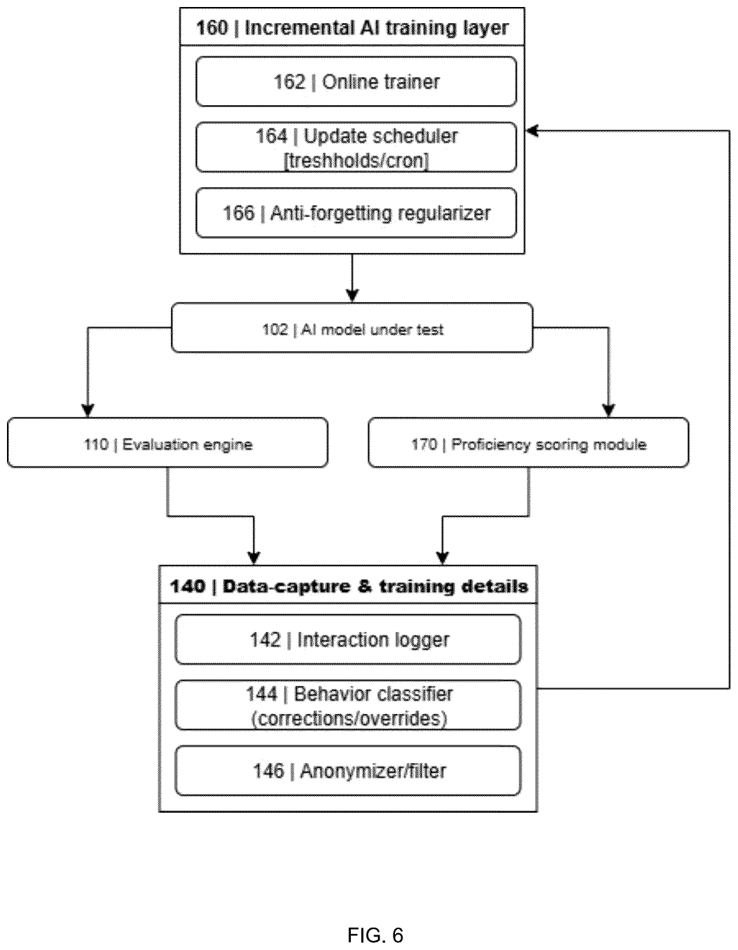

FIG. 7 is a block diagram of proficiency scoring with human benchmark, showing the scoring module 170 comprising category scorers 172 and composite aggregator 174, receiving reference data from a human-benchmark comparator/interface 175, and outputting an overall proficiency to the UI indicator 330.

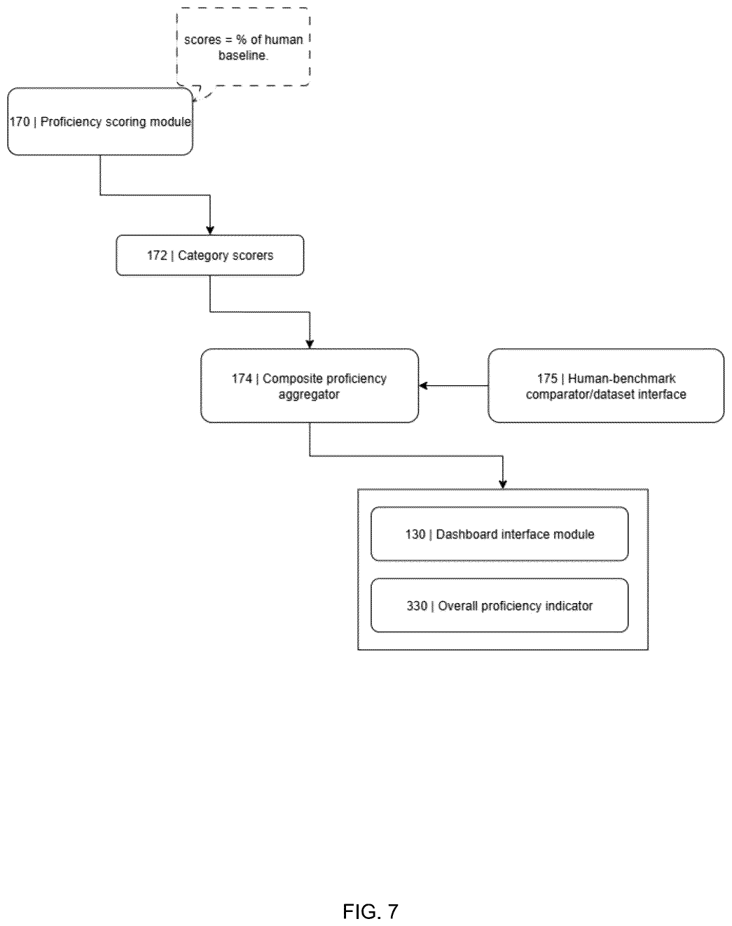

FIG. 8 is a UI detail of transparency features, illustrating the explainability panel 340, fairness/bias panel 338, alert indicator 336, and audit viewer 342, with a dashed linkage from a backend regression detector 184 to the alert indicator.

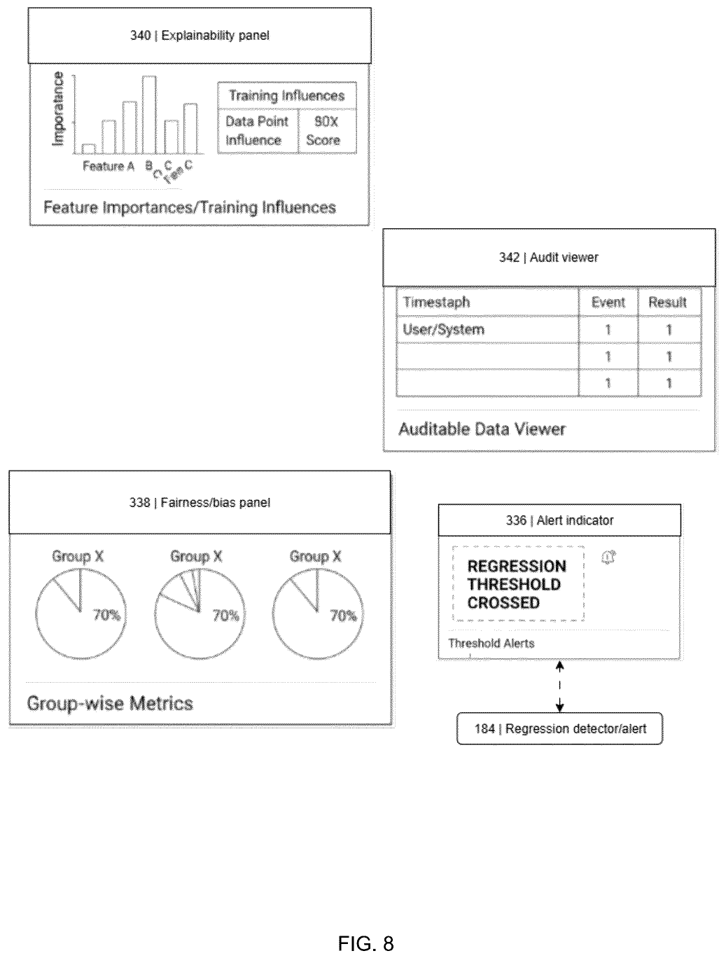

FIG. 9 is a block diagram of versioning and rollback, showing the versioning module 180 with version-ID assigner 182, regression detector/alert 184, and rollback controller 186, and illustrating rollback from a newer instance of the AI model 102 to a prior instance.

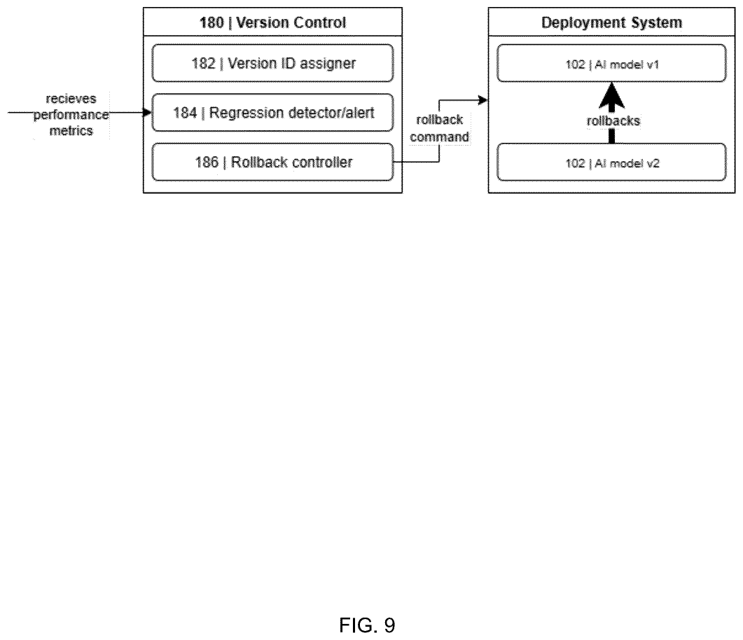

FIG. 10 is a schematic of security and privacy protections, wherein the subsystem 190 encloses the repository 120 and data capture layer 140, and provides encryption-in-transit 192, encryption-at-rest 194, and access control & audit 196, with audited records viewable via 342.

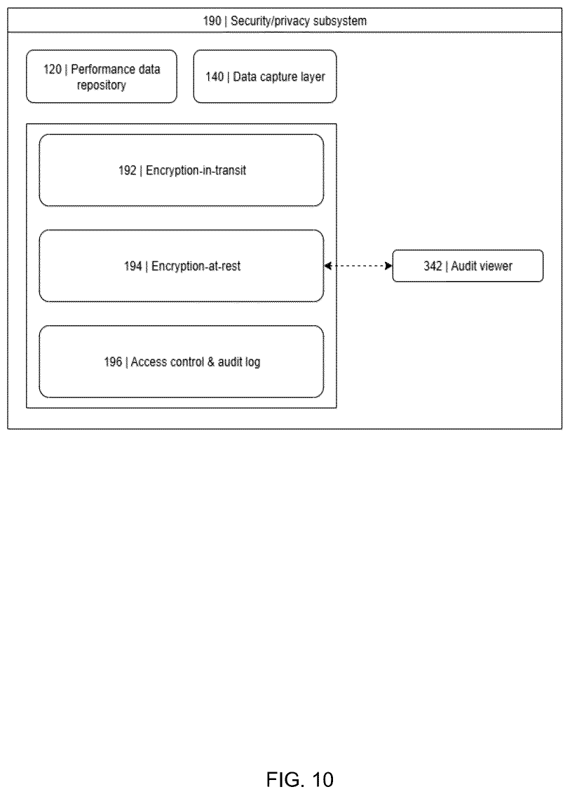

FIG. 11 is a UI wireframe of a comparative simulation tool within 332, including scenario parameters 350, a run control 352, and side-by-side results panes 354 (v1) and 356 (v2) for user-defined scenarios.

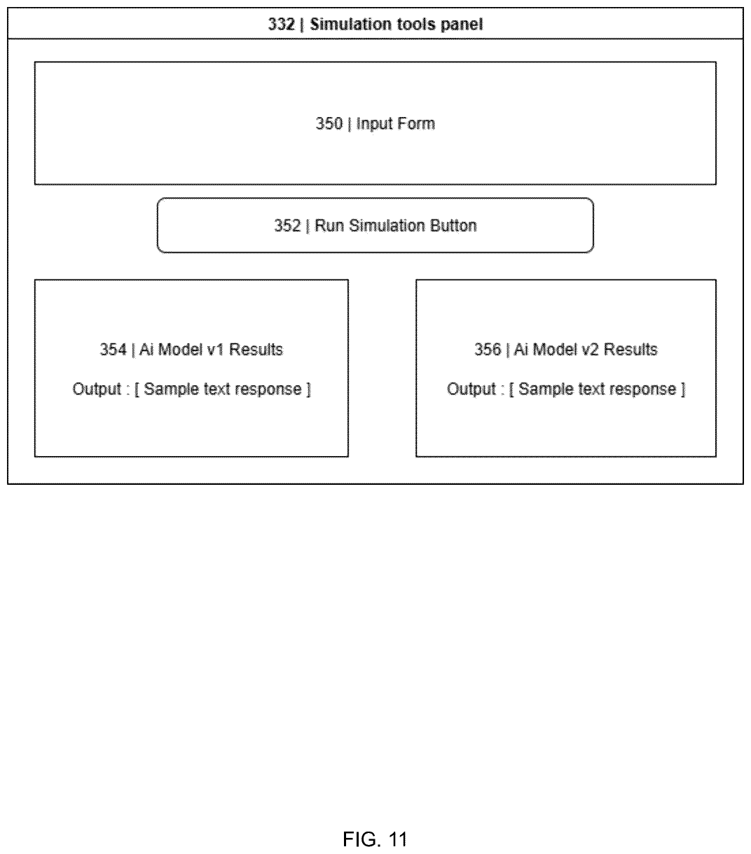

FIG. 12 is a flow diagram of CI/CD auto-evaluation, illustrating a model registry 802, a new-version event 804, an auto-evaluation job 806, a repository update 808, and a live dashboard refresh 810 to keep proficiency data current.

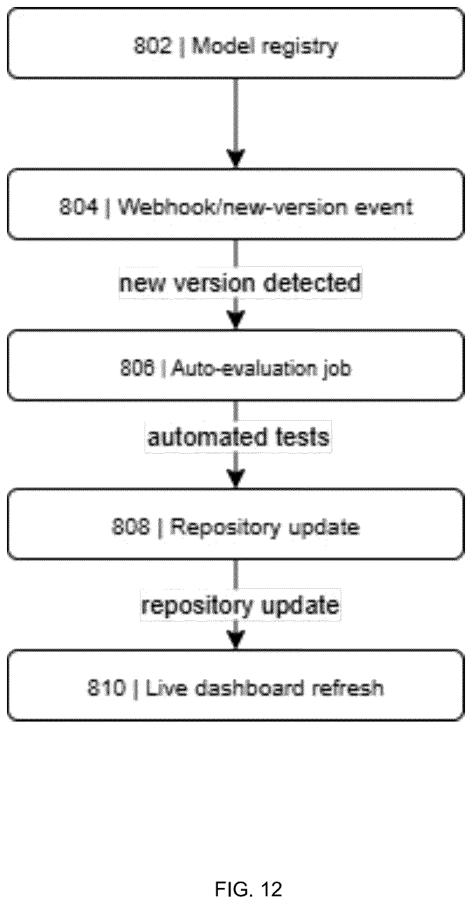

### DETAILED DESCRIPTION OF THE INVENTION

### Overview

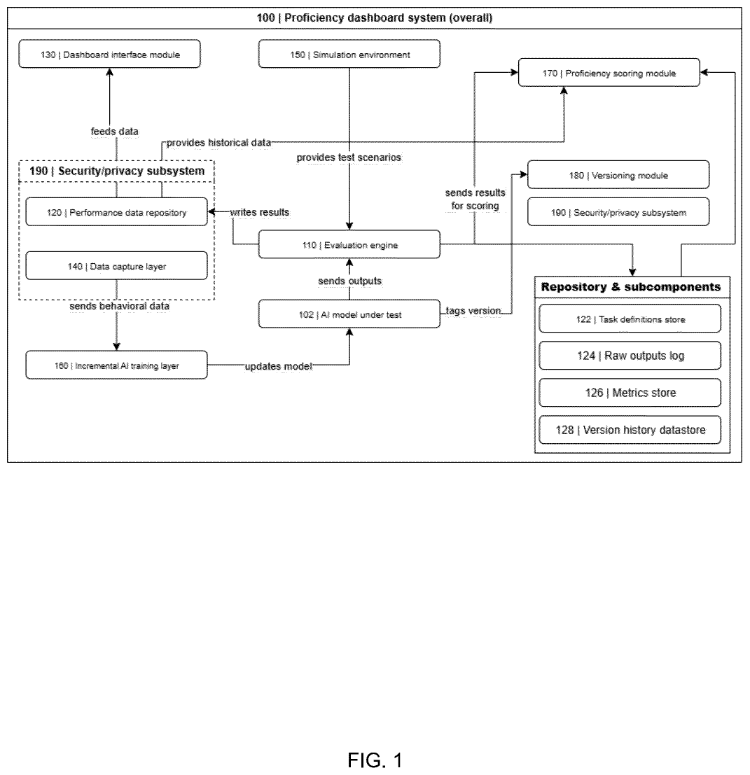

Referring to FIG. 1, a proficiency dashboard system evaluates an AI model via an evaluation engine, stores results in a performance data repository, and presents them through a dashboard interface module. A simulation environment optionally supplies dynamic scenarios. In certain embodiments (detailed below), optional modules include a data capture layer, incremental AI training layer, proficiency scoring module (including human-benchmark comparators), and versioning module.

### Definitions

“Proficiency metric/score” denotes a quantitative measure of model performance for a task or skill (e.g., accuracy, rate, percentile, composite score). In some embodiments, a proficiency score is normalized against human benchmark data (average or expert). “Task category” groups related tasks/skills. “Version” identifies a trained model snapshot. “Simulation” denotes a generated or replayed scenario exercising the model under controlled conditions.

### Components

Evaluation engine. The engine administers predefined tasks to the model, captures outputs, and computes performance metrics (binary, scalar, or composite). The engine can execute automated test suites and scenario runs from the simulation environment, then forward results for storage and visualization.

Simulation environment. The environment produces dynamic, domain-specific scenarios (e.g., multi-turn dialogues for LLMs; virtual scenes for perception systems) and streams inputs to the model. Outputs are evaluated for correctness, robustness, and policy adherence; results are treated as additional tasks for scoring and storage.

Performance data repository. The repository records task definitions, model inputs/outputs, computed metrics, timestamps, environment details, and version identifiers. It supports auditing and trend analysis, enabling retrieval of raw outputs for any evaluation.

Dashboard interface. The dashboard renders task-level metrics, category aggregates, and overall indicators; supports filtering by category, task, and version; and provides a dedicated comparison view to reveal improvements or regressions. Alerts may highlight metrics below thresholds or statistically significant regressions between versions.

Optional learning and transparency modules (embodiments) Data capture layer. In some embodiments, the system logs user interactions with model outputs (corrections, confirmations, overrides), behavioral context, and task metadata. The captured data is classified to identify where user intervention occurred, surfacing weaknesses for targeted training.

Incremental AI training layer. Using captured contextual data, the training layer updates model parameters online or in micro-batches, without full retraining, while mitigating catastrophic forgetting. Updates may be triggered by thresholds (e.g., volume of new interactions or drop in recent proficiency).

Proficiency scoring module with human benchmark. The module evaluates updated models against evaluation suites tied to human reference performance (e.g., average/expert accuracy/efficiency), expressing proficiency as a percentage/percentile relative to human benchmarks and optionally as category-wise sub-scores.

Versioning module. Each updated model is assigned a version identifier; proficiency scores and metadata are logged for longitudinal transparency. The dashboard can annotate the trend with major updates, flag regressions, and provide one-click rollback to a prior version in certain deployments.

Explainability and privacy. In embodiments, an explainability panel highlights training data most responsible for recent proficiency changes or shows feature importances for simulated tasks. The data capture pipeline anonymizes/filters sensitive data; logs are secured with encryption in transit and at rest; and authorized users can audit the data influencing proficiency changes.

### Method of Operation

The engine retrieves inputs, the model produces outputs, outputs are compared to expected results and metrics are computed per task. For each evaluation (including simulations), the repository records raw outputs and metrics keyed by version, enabling dashboard updates and version-to-version comparisons.

### Use Case

In an LLM-based customer-support assistant, the test suite includes FAQs, troubleshooting tasks, and bilingual translation; simulations include multi-turn dialogue. A new version improves FAQ accuracy and troubleshooting yet regresses on translation, which the comparison view highlights, prompting review before deployment.

### Deployment and Integration

The system integrates with CI/CD pipelines or model registries; upon detecting a new version, the evaluation engine runs, the repository updates, and the dashboard refreshes automatically. Embodiments compute fairness/bias metrics across data segments and display them alongside proficiency. Implementations may use general-purpose hardware, standard databases, web front-ends, and API-driven evaluation harnesses.

### Best Mode Contemplated

A preferred implementation employs: (i) automated evaluation harnesses that exercise both static task suites and interactive simulations; (ii) a normalized proficiency composite aggregating category sub-scores with human-benchmark scaling where available; (iii) repository schemas keyed by version-task-timestamp with stored raw outputs for audit; (iv) a web-based dashboard with real-time updates and side-by-side version comparison; and, where continuous learning is desired, (v) a controlled incremental training loop that prioritizes user-corrected interactions to remedy known weaknesses while preserving prior competencies.

1. A computer-implemented system for tracking and improving proficiency of an artificial intelligence (AI) model, the system comprising: a data capture layer configured to log user interactions and task context during operation of the AI model; an AI training layer communicatively coupled to the data capture layer and configured to incrementally update learned parameters of the AI model using captured context without full retraining; a proficiency scoring module configured to evaluate the AI model on predefined tasks and compute a proficiency score by comparing the AI model's performance to a human benchmark; a versioning module configured to assign version identifiers to successive AI model updates and to record, for each version, the corresponding proficiency score with a timestamp; and a dashboard interface module configured to present a real-time dashboard that displays a current proficiency score and a historical trend across versions and that provides interactive simulation tools enabling a user to specify hypothetical task scenarios and view expected performance of a selected version of the AI model.

2. The system of claim 1, wherein the data capture layer classifies user actions including corrections, confirmations, and overrides to identify model weaknesses for targeted retraining.

3. The system of claim 1, wherein the AI training layer performs online or micro-batch updates while preserving prior competencies to reduce catastrophic forgetting.

4. The system of claim 1, wherein the proficiency scoring module computes category-wise sub-scores that form a composite proficiency score, and the dashboard displays a breakdown across categories.

5. The system of claim 1, wherein the versioning module triggers an alert upon detecting a proficiency regression beyond a threshold and enables rollback to a prior version.

6. The system of claim 1, wherein the dashboard updates the displayed proficiency responsive to each completed evaluation run without manual refresh.

7. The system of claim 1, wherein the simulation tools permit side-by-side comparison of multiple AI model versions on a user-defined scenario.

8. The system of claim 1, further comprising an explainability panel that identifies captured interactions most influential on recent proficiency changes or provides feature-importance indicators for simulated tasks.

9. The system of claim 1, wherein the data capture layer anonymizes sensitive information and the repository encrypts logs in transit and at rest, and the dashboard provides authorized audit of data influencing proficiency changes.

10. A computer-implemented method comprising: logging user actions and task outcomes during operation of an AI model; selecting training-relevant interactions; incrementally updating the AI model with the selected interactions to form successive versions; evaluating each version on predefined tasks and computing a proficiency score relative to a human benchmark; storing each proficiency score in association with a corresponding version identifier and timestamp; and displaying, via a dashboard, a current proficiency score and a historical trend across versions together with interactive simulation of user-specified scenarios.

11. The method of claim 10, wherein incremental updates are triggered by thresholds including a volume of new interactions or a detected proficiency drop on recent tasks.

12. The method of claim 10, further comprising computing fairness metrics by comparing performance across dataset segments and surfacing those metrics on the dashboard.

13. A non-transitory computer-readable medium storing instructions that, when executed, cause one or more processors to perform the method of claim 10.

14. A proficiency monitoring system for an AI model, comprising: an evaluation module configured to administer predefined tasks to the AI model and to generate performance data; a data repository configured to store performance data and task-level proficiency metrics keyed to a version identifier; a dashboard interface module configured to display the proficiency metrics; and a version comparison component configured to present a comparative visualization of proficiency metrics for at least two versions of the AI model.

15. The system of claim 14, further comprising a simulation environment module configured to provide simulated test scenarios whose performance results are evaluated and stored as part of the predefined tasks.

16. The system of claim 14, wherein the dashboard interface module generates an alert if any proficiency metric falls below a predetermined threshold.

17. The system of claim 14, wherein the evaluation module computes one or more bias metrics and the dashboard interface displays the bias metrics.

18. The system of claim 14, wherein tasks are grouped into categories and the proficiency metrics include category aggregates.

19. The system of claim 14, wherein the repository stores, for each task, input provided to the model, the corresponding model output, and an evaluation result to enable audit.

20. The system of claim 14, wherein the evaluation module automatically executes tasks and updates the repository upon detecting a newly created or deployed model version.

21. A method for monitoring proficiency of an AI model, comprising: providing predefined tasks to the AI model; evaluating model outputs to compute task-level results; computing proficiency metrics from the results; storing the metrics in a repository keyed to a version identifier; and generating a dashboard display that presents the proficiency metrics.

22. The method of claim 21, further comprising retrieving proficiency metrics of a prior model version, comparing them to those of a current version, and highlighting differences on the dashboard.

23. The method of claim 21, wherein providing the tasks comprises generating an interactive simulated scenario and evaluating performance within the scenario.

24. A non-transitory computer-readable medium storing instructions that, when executed, cause processors to: administer predefined tasks; record performance results; calculate task-level proficiency metrics; store the metrics keyed to a version identifier; and generate a dashboard interface displaying the metrics.
